(19) United States
(12) Patent Application Publication
(10) Pub. No.: US 2017/0043697 A1
(43) Pub. Date: Feb. 16, 2017

(54) Bed sled

(71) Applicant: CLYDE DAVID WOODEN, JR., SOUTH PITTSBURG, TN (US)

(72) Inventor: CLYDE DAVID WOODEN, JR., SOUTH PITTSBURG, TN (US)

(21) Appl. No.: 14/756,172

(22) Filed: Aug. 13, 2015

(51) Int. Cl. B60P 1/00; B60P 1/52

(52) U.S. Cl. CPC B60P 1/00; B60P 1/52

(57) ABSTRACT

This particular concept concerning types of pull-out truck beds is new to the industry. The Bed Sled makes this concept a reality by providing a simple way to make loading and unloading your truck much faster and easier.

### BACKGROUND OF THE INVENTION

A short background of the Bed Sled follows: Concerning loading and unloading trucks and the truck bed and bed liner fields.

I am continuously loading and unloading my pick-up truck with my tools and all kinds of heavy things. This proved to be a hard and time consuming task, especially for only one person. However, when I invented the “Bed Sled”, my life became much easier.

I got the idea when I put down a big piece of cardboard in my truck bed to keep garbage from getting on my bed. I quickly learned that I could pull anything from the front of the bed to the back by pulling the cardboard to me. I could also load just as easily. Soon I cut holes in the cardboard for handles and put two pieces of cardboard, one for the left half of my bed and one for the right—perfect. Everyone with a truck needs a Bed Sled!

### BRIEF SUMMARY OF THE INVENTION

Loading and unloading your truck bed can be time consuming and hard, especially for one person. The “Bed Sled” is a great invention that creates a simple and easy way to load and unload your truck bed. It can be easily made of any slick and sturdy material. The Bed Sled is simply a flat piece of material (plastic, fiberglass, polymers, etc.) with a hole cut in one end for a handle. It can be smooth or ribbed (like some truck bed liners are ribbed). You can use one or more of any size to meet your specific needs. The Bed Sled can go in your truck bed as is, or can be made as part of a truck bed liner using wheels and/or track systems.

### DETAILED DESCRIPTION OF THE INVENTION

The following is a detailed description of the “Bed Sled”: This is a device that is simple and straight forward, yet will make loading and unloading truck beds much easier and faster.

In its simplest form, the Bed Sled is a flat piece of plastic, fiberglass, polymers or other sturdy material (extruded, pressed, molded, cut, etc.) that may have a hole cut out or formed in one or more places, or an attached handle in one or more places, to use for a handle to push and pull the Bed Sled. The Bed Sled may be equipped with raised sides and ends to keep material from sliding off the Bed Sled. These sides can be easily formed at the time the main body of the Bed Sled is extruded, pressed, molded, cut, etc. The Bed Sled can be either smooth (like a table top), ribbed (in the same fashion that some truck bed liners have a ribbed design), or smooth on one side and ribbed on the other (any type texture can be used). The ribbed design will allow the Bed Sled to fit onto the ribbed truck bed liner and give it more stability should the customer desire this option. However, truck bed liners are not required in order to use the Bed Sled.

The thickness of the Bed Sled can range from approximately ⅛ inch to ¼ inch depending on the application and type of material used (although, thickness can be made smaller or larger than these dimensions should the customer require it). Length and width are dependent upon customer needs and truck bed size. For example, for a pickup truck with a bed size of 4 feet wide and 8 feet long, the Bed Sled could be approximately the same width and length, or two or more Bed Sleds of smaller dimensions could be used side by side in the truck bed. The Bed Sled does not necessarily need to cover the entire length or width of the truck bed; this is up to the consumer.

To use the Bed Sled is simple common sense. For example, if you desire to load your truck bed with luggage, simply stand on the ground at the rear of the truck bed and (with the Bed Sled lying flat on the truck bed and the handle on the end closest to you) pull the Bed Sled toward you until you can reach the spot on the Bed Sled that you want to put your luggage. Then place the desired piece or pieces of luggage on that spot and push the Bed Sled back into the truck bed slightly and place the next piece(s) of luggage. Repeat this until the Bed Sled is full or your luggage has all been loaded. When finished, push the Bed Sled all the way into the truck bed (close the tail gate and cover the truck bed if desired). To unload, simply reverse the process.

The Bed Sled can also be received into a track system made into the truck bed or truck bed liner. The track system would also be very simple. It could consist of simply a space cut out or otherwise made in the truck bed liner to allow the Bed Sled to slide in and out of the liner. It could be tracks of metal or other material molded or otherwise placed into the bed liner. These tracks or “grooves” could also be molded, pressed, or cut into the plastic, fiberglass, or other material at the time the truck bed liner is formed (thus the tracks would be made of that very same material). Furthermore, the track or track system could be welded or otherwise attached to the actual truck bed (this would work with or without a bed liner). All these would work basically the same way as antique kitchen cabinet drawers do. The Bed Sled would slide in the space or the tracks or grooves with each of its sides as it is pushed and pulled in and out of the truck bed. This would allow the Bed Sled to be almost flush with any bed liner instead of riding on top of the liner. In this way, the Bed Sled would actually be a pull-out part of the bed liner.

In order to accommodate the insertion of these tracks in bed liners, the material of the truck bed liner where the track is inserted may be required to be thicker than the main body of the truck bed liner. Likewise, in order to better utilize the tracks, the edges on each side of the Bed Sled may need to be thicker than the main body of the Bed Sled.

A thin flat piece of bed liner material could be made into the bed liner under the sliding area of the Bed Sled (or placed on the actual truck bed, if no bed liner is used). Thus, the Bed Sled would not be sliding on the material of the actual truck bed.

Furthermore, the Bed Sled could be equipped with small wheels. These wheels could be molded or formed into the edges of the Bed Sled at the time the Bed Sled is formed, or holes could be drilled in the edges of the Bed Sled and wheels inserted after it has been made. This would require a certain thickness for the Bed Sled depending on how big and sturdy the wheels desired (the increased thickness could be only on the edges of the Bed Sled and not necessarily its entire body). Also, these wheels would need to be placed several on each side of the Bed Sled depending on how heavy the load it would be handling and how thick and sturdy the Bed Sled material. Also, rollers (like elongated wheels) could be used either in placed of or in conjunction with wheels. Rollers would work best in conjunction with wheels and placed under the body of the Bed Sled. This would require spaces or grooves in the bottom of the Bed Sled where rows of axles and rollers could be embedded to help support weight. (All these things depend on customer requirements).

Although the wheeled Bed Sled can work without tracks, it can be received into a space or track system made into the truck bed or truck bed liner. The track system would also be very simple. It could be tracks of metal or other material molded or otherwise placed into the bed liner. These tracks or “grooves” could also be molded, pressed, or cut into the plastic, fiberglass, or other material at the time the truck bed liner is formed. Furthermore, the track or track system could be welded or otherwise attached to the actual truck bed (this would work with or without a bed liner). All these would work basically the same way as many modern kitchen cabinet drawers do (with the Bed Sled usually requiring more wheels). The Bed Sled would slide in the space, tracks or grooves with each of its sides as it is pushed and pulled in and out of the truck bed. This would allow the Bed Sled to be almost flush with any bed liner instead of riding on top of the liner. In this way, the Bed Sled would actually be a pull-out part of the bed liner.

In order to accommodate the insertion of tracks in the bed liner, the material of the truck bed liner where the track is inserted may be required to be thicker than the main body of the truck bed liner.

Once again, a thin flat piece of bed liner material could be made into the bed liner under the sliding area of the Bed Sled (or placed on the actual truck bed, if no bed liner is used). Thus, the Bed Sled would not be sliding or rolling on the material of the actual truck bed.

NOTE: Truck bed liners referred to in this description are not the type sprayed on to the truck bed.

I claim the invention:

1. I claim the Bed Sled, that it is a piece of any material (of any size and manufactured in any way) that can lay in or on a truck bed and allow for various item(s) and/or material(s) to be placed on it, and that may or may not have a hole(s) in one or more places for a handle (or for any other reason) or an attached piece(s) of material(s) in one or more places for a handle (or for any other reason), and that such hole(s) or attached piece(s) of material(s) may be used to push and/or pull or otherwise manipulate the Bed Sled (or for any other reason), and that the Bed Sled can be smooth, ribbed, or any other texture on either side, and that the Bed Sled may or may not have raised sides and/or ends to keep item(s) and/or material(s) from sliding off the Bed Sled, and that, when any item(s) and/or material(s) are placed on the Bed Sled, the Bed Sled can be used to push and/or pull or otherwise manipulate said item(s) and/or material(s) into and/or out of truck beds or off of and/or on to truck beds or to otherwise manipulate said item(s) and/or material(s) within or on truck beds by providing a time-efficient means of movement for these item(s) and/or material(s), and that more than one Bed Sled can be utilized in a single truck bed, and that the Bed Sled can be used for any purpose associated with truck beds if it is found to be helpful in that purpose.

2. I also claim for the invention entitled Bed Sled, all specifications in claim 1 and, in addition to the first claim, all modifications to any truck bed or truck bed liner that may be made to the truck bed or truck bed liner in order for it to accommodate or be used with the Bed Sled (in any of its forms) and that these modifications are part of the invention entitled Bed Sled, and that the Bed Sled can be contained inside any truck bed or truck bed liner by use of a space in, on, or associated with the truck bed or truck bed liner, and/or a track or track system in, on, or associated with the truck bed or truck bed liner, any of which are made for the Bed Sled to operate in or on, with such space and/or track or track system placed into, on, or in association with the truck bed or truck bed liner by any means or attached to the truck bed or truck bed liner in any way as to allow the Bed Sled to move in and/or out of the truck bed, or onto and/or off of the truck bed, or otherwise be manipulated within or on the truck bed, or in or on the said space and/or track or track system, and that a piece of material may or may not be placed under the sliding area of the Bed Sled, thus keeping the Bed Sled from sliding on the material of the actual truck bed if said material was placed under said sliding area.

3. I also claim for the invention entitled Bed Sled, all specifications in claim 1 and, in addition to the first claim, that the Bed Sled can be equipped with wheels, rollers, and/or any other device(s) to facilitate movement (any of which may or may not contain bearings), and these can be made of any material or be any size that will facilitate the Bed Sled movement, and these wheels, rollers, and/or other device(s) can be part of the Bed Sled by any means desired, and that any number of wheels, rollers, and/or other device(s) can be used, and that the Bed Sled, with associated wheels, rollers, and/or other movement facilitating device(s) can be contained inside any truck bed or truck bed liner by use of a space in, on, or associated with the truck bed or truck bed liner, and/or a track or track system in, on, or associated with the truck bed or truck bed liner, any of which are made for the Bed Sled to operate in or on, with such space and/or track or track system placed into, on, or in association with the truck bed or truck bed liner by any means or attached to the truck bed or truck bed liner in any way as to allow the Bed Sled to move in and/or out of the truck bed, or onto and/or off of the truck bed, or otherwise be manipulated within or on the truck bed, or in or on the said space and/or track or track system, and that a piece of material may or may not be placed under the sliding area of the Bed Sled, thus keeping the Bed Sled from sliding or rolling on the material of the actual truck bed if said material was placed under said sliding area, and furthermore, that the Bed Sled with associated wheels, rollers, and/or any other device(s) to facilitate movement can be used without a space and/or track or track system in, on, or associated with the truck bed or truck bed liner and can operate with any truck bed liner without truck bed liner modifications, or can operate in or on a truck bed with no liner and/or no truck bed modifications.
